(19) United States
(12) Patent Application Publication
(10) Pub. No.: US 2003/0040915 A1
(43) Pub. Date: Feb. 27, 2003

(54) Method for the voice-controlled initiation of actions by means of a limited circle of users, whereby said actions can be carried out in appliance

(76) Inventor: Roland Aubauer, Bocholt (AT)

Correspondence Address: BELL, BOYD & LLOYD, LLC, P. O. BOX 1135, CHICAGO, IL, 60690-1135, US

(21) Appl. No.: 10/220,906

(22) PCT Filed: Mar. 8, 2001
(86) PCT No.: PCT/DE01/00891

(30) Foreign Application Priority Data
Mar. 8, 2000 (DE) 100 11 178.5

(51) Int. Cl. G10L 11/00

(52) U.S. Cl. 704/275

(57) ABSTRACT

The aim of the invention is to control initiation of actions in a user-independent manner and by means of voice and users pertaining to a limited circle of users of an appliance, whereby said actions can be carried out in the appliance. The voice is detected on the basis of a speaker-dependent voice detection system in a user-independent manner and without user identification. The reference voice patterns of all users pertaining to a voice detection system are allocated to detection voice expressions, e.g. the words of a vocabulary, of the users pertaining to the circle of users, whereby said patterns are required for detection.

The input of bits of information or, respectively, of data or commands into an appliance—e.g. a telecommunication terminal device such as the wire-bound telephone or the wireless telephone, the mobile radio telephone etc., a household appliance such as the washing machine, the electric stove, the refrigerator etc., an appliance of the entertainment electronics such as the television, the stereo system, etc., an electronic devices [sic] for controlling and entering commands such as the personal computer, the personal digital assistant, etc.—by means of voice, which is the natural way of communication of the human being, for the voice-controlled initiation of actions that can be carried out in the respective device, has the primary aim that the hands used for entering data or commands become free for other routine tasks.

For this purpose, the appliance has a voice recognition device which is also referred to as voice recognizer in the technical literature. The field of the automatic recognition of speech as a system of characters and sounds comprises the recognition of the characters and sounds spoken in an isolated manner—e.g. individual words, commands—up to the recognition of fluently spoken signs and sounds—e.g. a number of coherent words, one or more sentences, a speech—corresponding to the type of communication of the human being. The automatic speech recognition basically is a search process which, according to the printed publication “Funkschau number 26, pages 72 to 74” can be roughly divided into a phase for editing the voice signal, a phase for reducing the amount of data, a classification phase, a phase for forming word chains and into a grammar model phase, whereby said phases occur as cited in the speech recognition process.

The voice recognizers operating according to this course of action are differentiated with respect to the degree of their speaker dependency (see printed publication “Funkschau number 13, 19998 [sic], pages 78 to 80”). Given speaker-dependent voice recognizers, the respective user speaks-in the entire vocabulary in at least one learning phase or, respectively, training phase in order to generate reference patterns, whereby this process does not occur for speaker-independent voice recognizers.

The speaker-independent voice recognizer operates almost exclusively on the basis of phonemes whereas the speaker-dependent voice recognizer, more or less, is a recognizer of individual words.

According to this voice recognition definition, the speaker-independent voice recognizers are used particularly in devices in which fluently spoken speech—e.g. a number of coherent words, sentences etc.—and large vocabulary up to extremely large vocabulary—i.e. an unlimited user circle uses the device—must be processed and in which the computing outlay and storing outlay does not play a role regarding the recognition of this speech and vocabularies since the corresponding capacities are present.

On the other hand, the speaker-dependent voice recognizers are preferably used in devices wherein discretely spoken speech, e.g. individual words and commands, small vocabularies up to medium-size vocabularies—i.e. a limited user circle uses the device—must be processed and wherein the computing outlay and storing outlay does play a role with respect to the recognition of this speech and vocabularies since the corresponding capacities are not present. Therefore, the speaker-dependent voice recognizers are characterized by less complexity regarding the computing outlay and the storing need.

Given currently used speaker-dependent voice recognizers, sufficiently high word recognition rates are already obtained for small vocabularies up to medium-size vocabularies (10-100 words), so that these voice recognizers are particularly suitable for the control input and command input (command-and-control) but also for the voice-controlled database access (e.g. speech selection from a telephone book). Therefore, these voice recognizers are increasingly used in appliances of the mass market such as in telephones, household appliances, appliances of the entertainment electronics, devices having control input and command input, toys and also in motor vehicles.

A problem with respect to these applications is that the appliances often are not only used by one user but by a number of users, e.g. frequently the members of a household, a family (limited user circle).

The printed publication “ntz (technical news magazine) volume 37, number 8, 1984, pages 496 to 499, page 498, in particular, the last seven lines of the middle column up to the first six lines of the right column”, only avoids the problem by separate vocabularies for the individual users. The disadvantage of this avoidance method is that the users must identify themselves prior to the use of the voice recognition. Since a speaker-dependent voice recognition has been assumed, the speaker must be identified via another method than the voice recognition. In most cases, the user identifies himself via a keyboard and a display. The access to the automatic voice recognition is significantly more difficult for the user concerning the user prompting and the time outlay that is necessary for a voice recognition. This is particularly valid with respect to frequently changing users of a voice recognition. The method of the manual user identification even questions the value of the voice recognition since the desired execution of the action, with the same outlay, can be manually initiated in the device and without speech recognition instead of the manual user identification

An object of the invention is to control the initiation of actions in a user-independent manner and by means of voice and users of a limited circle of users of an appliance, whereby said actions can be carried out in the appliance, whereby the voice is recognized on the basis of a speaker-dependent voice recognition system in a user-independent manner and without user identification.

This object is achieved by the features of patent claim 1.

The inventive idea is that reference voice patterns of all users of a voice recognition system are allocated to recognition voice expressions, e.g. the words of a vocabulary, of the users of the user circle, whereby said patterns are required for detection. The vocabulary (telephone book, command word list, . . . ), for example, contains “i” words (names, commands, . . . ), whereby an action to be carried out (telephone numbers to be dialed, action of a connected appliance, . . . ), a potential voice confirmation to be acoustically provided (normally the pronunciation of the word) (voice prompt) and up to “j” reference speech patterns of the “k” users of the voice recognition system are allocated to said “i” words, whereby “i” N, “j” N and “k” N.

The allocation of a speech confirmation to the words of a vocabulary is not absolutely necessary but frequently is advantageous for an acoustic user prompting. The speech confirmation can be from one of the users of the voice recognition system, a text-to-voice-transcript system or from a third person if the words of the vocabulary are fixed.

The up to “j” reference voice patterns of a word are acquired in that m users train the voice recognizer. It is not absolutely necessary that all users train all words of the vocabulary but only the words which later are to be automatically recognized by an individual user. If a number of users train the same word, the training of the n-^{th} speaker is also accepted when the reference voice pattern generated by the voice recognizer is similar to the already stored reference voice patterns of the word of the previously trained speakers. The words trained by the individual users form subsets of the entire vocabulary, whereby the intersections of the sub-vocabularies are the words that are trained by a number of users.

After the reference voice patterns have been generated (training of the voice recognizer), all users can use the voice recognition system without previous user identification. Given the automatic word recognition, a rejection (non-acceptance of the voice recognition since the expression cannot unambiguously be allocated to a reference voice pattern) does not occur if the recognition voice pattern generated by the voice recognizer is similar to a number of reference voice patterns of a word but is not similar to the reference voice patterns of different words.

An advantage of the method is the user-independent voice recognition. This means that the users must not be identified given the voice recognition. Therefore, a significantly simpler operation of the voice recognition system is obtained. Another advantage of the method is the common vocabulary for all speakers. The administrative outlay of a number of vocabularies is foregone and increased clarity is achieved for the users. Since only one voice confirmation (voice prompt) must be stored for each word of the vocabulary, the method also allows a significant reduction of the storing outlay.

The storing outlay for a voice confirmation is approximately higher by a power of ten than the storing outlay of a reference voice pattern. First of all, the presented method normally obtains a higher word recognition rate compared to an individual use (only one speaker) of the voice recognizer. The improvement of the word recognition rate is based on the expanse of the voice reference basis of a word by the training with a number of speakers.

The inventive step is the use of a common vocabulary for all users of a voice recognition system, whereby the reference voice patterns of a number of speakers are allocated to a word. The method requires the previously described rejection strategy given voice training and voice recognition.

The method is appropriate for voice recognition applications having a limited circle of users of more than one user. In particular, these are applications with a voice control input and command input but also with a voice-controlled database access. Exemplary embodiments are voice-controlled telephones (voice-controlled selection from a telephone book, voice-controlled control of individual functions such as the function of the answering machine) but also other voice-controlled machines/devices such as household appliances, toys and motor vehicles.

Advantageous embodiments of the invention are provided in the subclaims.

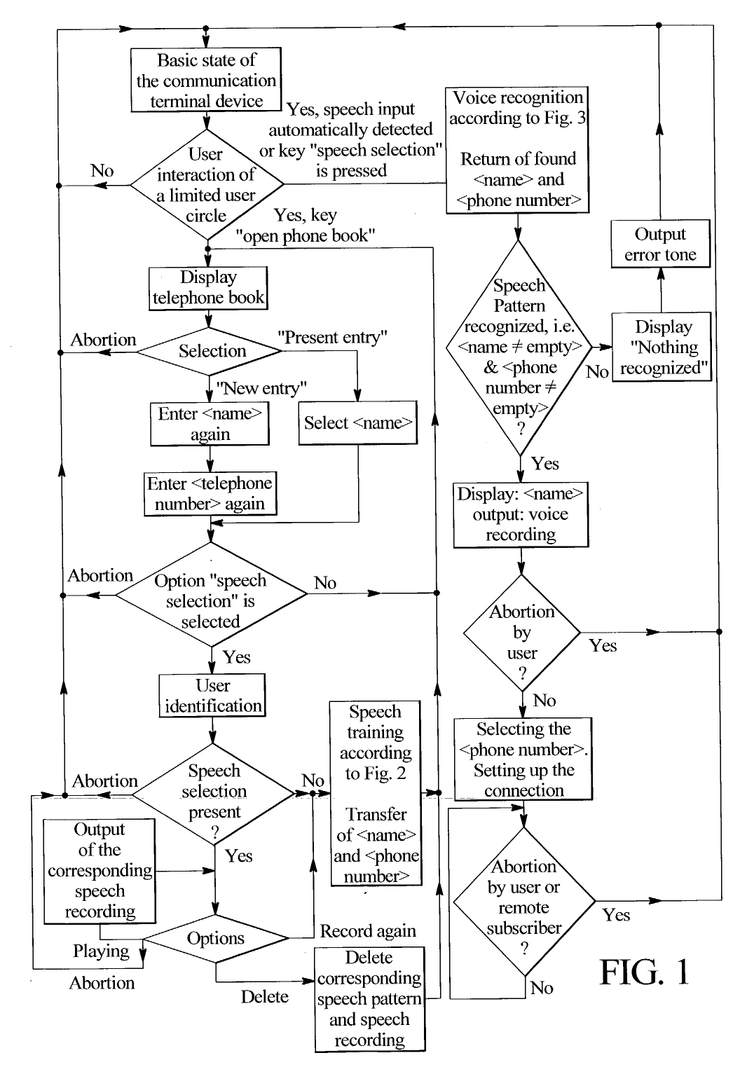

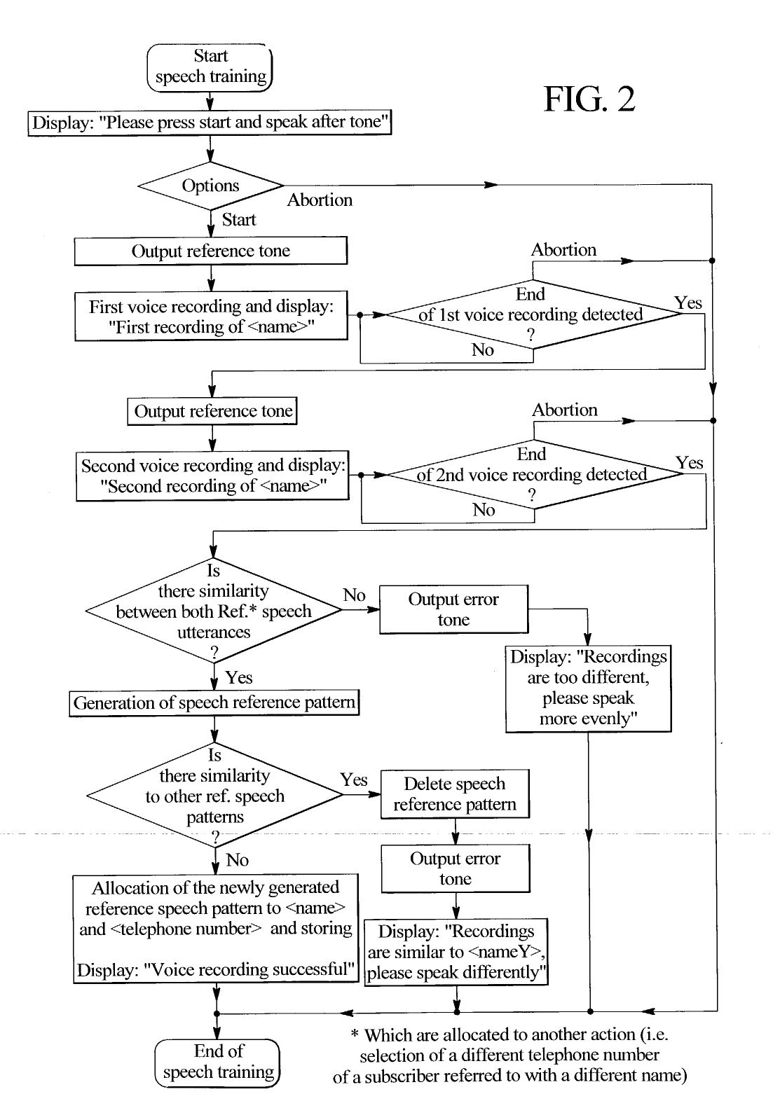

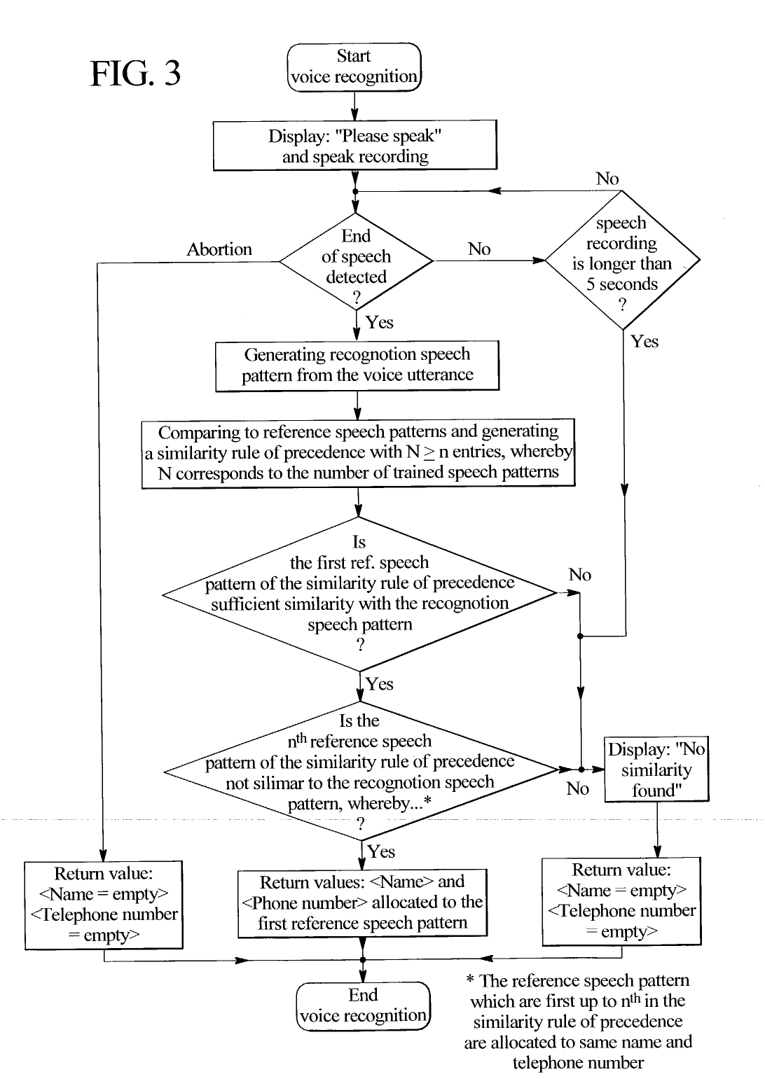

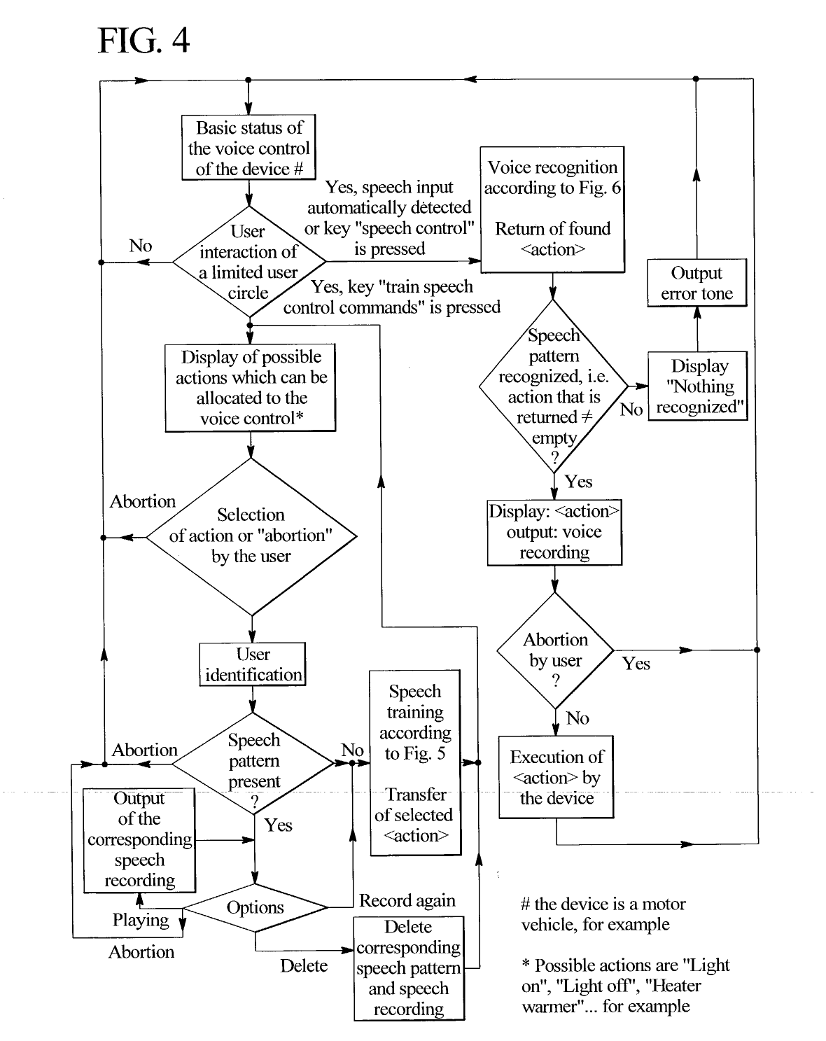

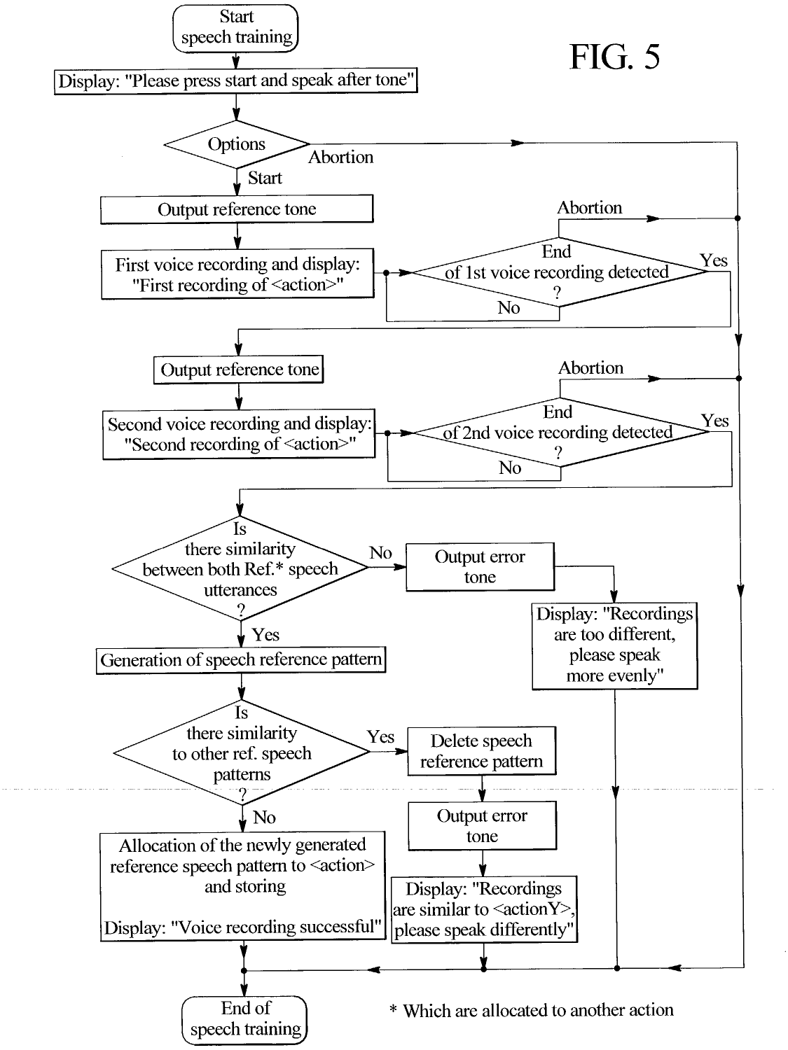

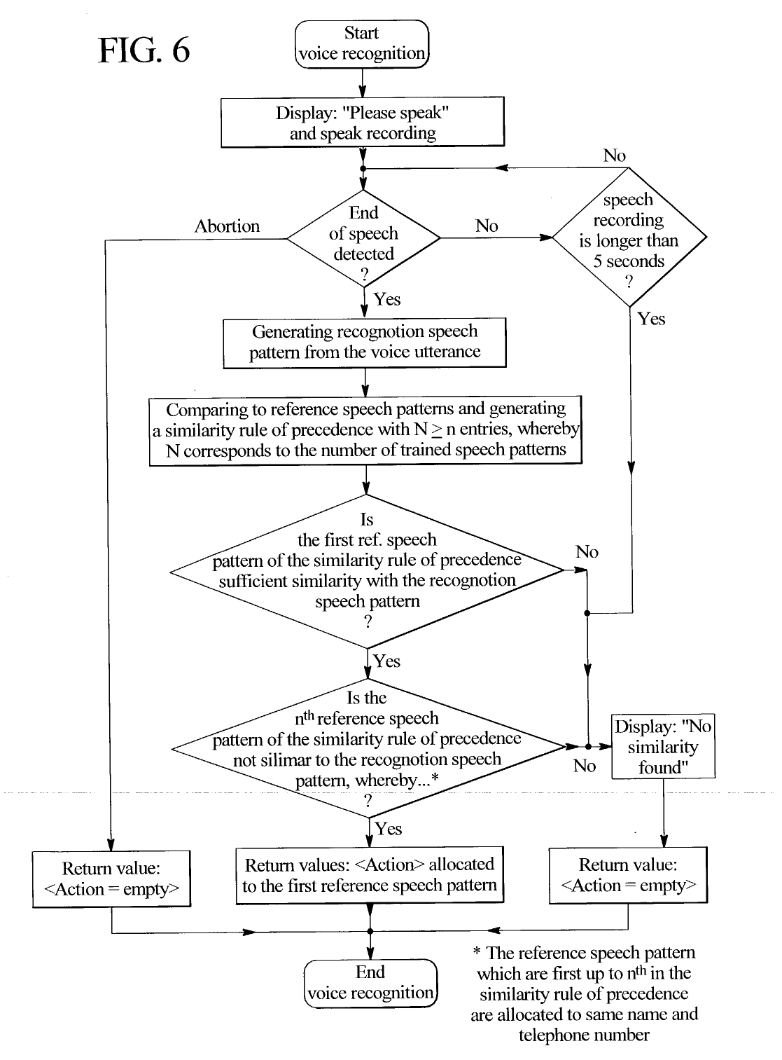

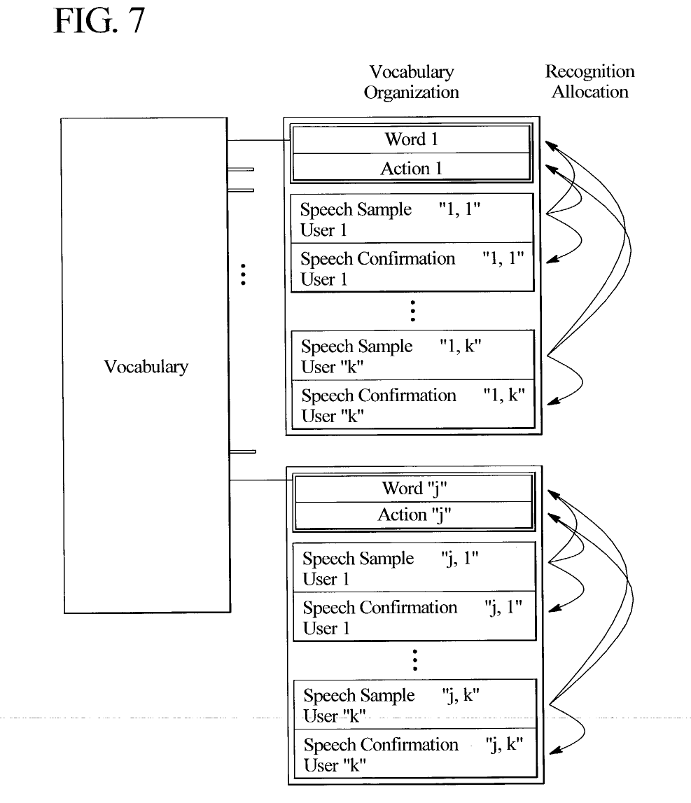

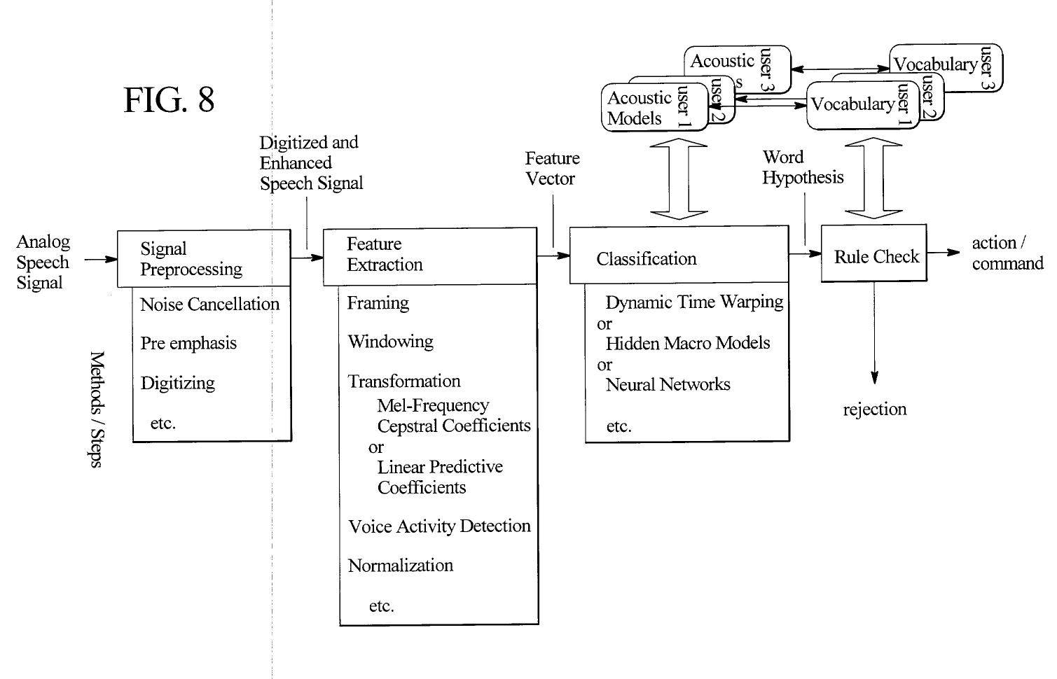

The FIGS. 1 to 8 explain an exemplary embodiment of the invention.

1. Method for the voice-controlled initiation of actions by means of a limited circle of users, whereby said actions can be carried out in an appliance, comprising the following features:
(a) On the basis of the voice pertaining to at least one user of the user circle of the device, the device, for at least one operating mode selected by the respective user, is trained in at least one speech training phase to be initiated by the user such that
(a1) at least one of the users, with respect to at least one action, enters at least one reference speech utterance into the device, whereby said reference speech utterance is respectively allocated to the action,
(a2) a reference speech pattern is generated from the reference speech utterance by speech analysis, whereby the reference speech pattern, given a plurality of reference speech utterances, is generated when the reference speech utterances are similar,
(a3) the reference speech pattern is allocated to the action,
(a4) the reference speech pattern is unconditionally stored with the allocated action or is only stored when the reference speech pattern is not similar to the already stored other reference speech patterns which are allocated to other actions,
(b) the respective user, in a voice recognition phase, enters a recognition speech utterance into the device for the operating mode of the device selected by the user,
(c) a recognition speech pattern is generated from the recognition speech utterance by speech analysis,
(d) the recognition voice pattern is compared to at least a part of the reference speech patterns, which are stored for the selected operating mode, such that the similarity between the respective reference speech pattern and the recognition speech pattern is detected and such that a similarity rule of precedence of the stored reference speech patterns is formed on the basis of the detected similarity values,
(e) the voice-controlled initiation of the action to be carried out in the device by the user—whereby said voice-controlled initiation is caused by the recognition voice utterance—is admissible when the recognition speech pattern is similar to the reference speech pattern which is first in the similarity rule of precedence or when the recognition speech pattern is similar to the reference speech pattern which is first in the similarity rule of precedence and when said recognition speech pattern is not similar to the reference speech pattern situated at the n-^{th} position in the similarity rule of precedence, whereby another action is allocated to the reference speech pattern situated at the n-^{th} position in the similarity rule of precedence than to the action that is allocated to the reference speech pattern which is first in the similarity rule of precedence and whereby the reference speech patterns, from the first to the (n−1)^{th} position with respect to the similarity rule of precedence, are allocated to the same action,
(f) the action, which is allocated to the reference speech pattern situated first in the similarity rule of precedence, is only carried out when the recognition voice utterance, in a speech recognition phase, entered by the user into the device for the operating mode of the device selected by the user has been recognized as allowable.

2. Method according to claim 1,
characterized in that
a plurality of speech patterns are defined as similar when a distance measure between respectively two speech patterns downwardly transgresses a prescribed value, whereby said distance measure is determined by analysis, or downwardly transgresses a prescribed value and is similar to this value, whereby the distance measure indicates the distance of the one speech pattern from the other speech pattern.

3. Method according to claim 2,
characterized in that
the distance measure is detected or, respectively, calculated [. . . ] method with the dynamic programming (dynamic time warping) of the Hidden-Markov-Modeling or the neural networks. [sic]

4. Method according to one of the claims 1 to 3,
characterized in that
the user enters at least one word as a reference speech utterance.

5. Method according to one of the claims 1 to 4,
characterized in that
the user allocates at least one user-specific identification to the speech training phases carried out by said user.

6. Method according to one of the claims 1 to 5,
characterized in that
the device automatically controls the user input of a plurality of reference speech utterances pertaining to a speech training phase in that the end of the first-entered reference speech pattern is recognized by the device on the basis of a speech activity detection since a further speech activity allocating to this reference voice utterance did not occur by the user within a prescribed time, and since the device informs the user of the chronologically limited input possibility of at least one further reference voice utterance.

7. Method according to one of the claims 1 to 5,
characterized in that
the user input of a plurality of reference voice utterances pertaining to a speech training phase is controlled by interaction between the user and the device in that the user informs the device, by a specific operating procedure, that he will enter a plurality of reference speech utterances.

8. Method according to one of the claims 1 to 7,
characterized in that
the users, in different speech training phases, enter different reference voice utterances with respect to an action, e.g. in different languages “German and English”.

9. Method according to one of the claims 1 to 8,
characterized in that
the user enters a bit of information, e.g. a telephone number, by which the action is defined.

10. Method according to claim 9,
characterized in that
the bit of information is entered by biometric input techniques.

11. Method according to one of the claims 1 to 10,
characterized in that
the bit of information is entered before or after the input of the reference voice utterance.

12. Method according to one of the claims 1 to 11,
characterized in that
the action is prescribed by the device.

13. Method according to one of the claims 1 to 12,
characterized in that
the recognition voice utterance, in the speech recognition phase, can be entered any time except during the speech training phase.

14. Method according to one of the claims 1 to 13,
characterized in that
the recognition speech utterance cannot be entered until the user has initiated the voice recognition phase in the device.

15. Method according to one of the claims 1 to 14,
characterized in that
the speech training mode is respectively ended by storing the reference speech pattern.

16. Method according to one of the claims 1 to 15,
characterized in that
the user is informed of the input of an inadmissible recognition voice pattern.

17. Method according to one of the claims 1 to 16,
characterized in that
the speech recognition phase is initiated in the same way as the speech training phase.

18. Method according to one of the claims 1 to 17,
characterized in that
the voice-controlled initiation of actions, which can be carried out in an appliance, is performed in telecommunication terminal devices.

19. Method according to one of the claims 1 to 17,
characterized in that
the voice-controlled initiation of actions, which can be carried out in an appliance, is performed in household appliances, in motor vehicles, in appliances of the entertainment electronics, in electronic devices for the control input and command input, e.g. a personal computer or a personal digital assistant.

20. Method according to claim 17,
characterized in that
the speech selection from a telephone book or the voice-controlled transmission of “Short Message Service” messages from a “Short Message Service” memory is carried out in a first operating mode of the telecommunication terminal device.

21. Method according to claim 17 or 20,
characterized in that
the voice control of function units, such as answering machines, “Short Message Service” memories, is carried out in a second operating mode of the telecommunication terminal device.
